(19) United States
(12) Patent Application Publication
(10) Pub. No.: US 2023/0400603 A1
(43) Pub. Date: Dec. 14, 2023

(54) METHOD OF PROJECTING FUTURE FLOOD RISKS UNDER CHANGING HYDROLOGICAL CYCLES

(71) Applicant: Wuhan University, Wuhan (CN)

(72) Inventors: Jiabo YIN, Wuhan (CN); Xi HUANG, Wuhan (CN); Yuanhang YANG, Wuhan (CN); Shengyu KANG, Wuhan (CN); Xinhui WANG, Wuhan (CN)

(21) Appl. No.: 17/948,211

(22) Filed: Sep. 19, 2022

(30) Foreign Application Priority Data
Jun. 9, 2022 (CN) 202210650913.2

(51) Int. Cl. G01W 1/10; G06N 20/00

(52) U.S. Cl. CPC G01W 1/10; G06N 20/00

(57) ABSTRACT

A flood risk prediction method includes: collecting basic meteorological hydrological data of a basin by using a data collection and storage box; calibrating a basin hydrological model and a machine learning model; obtaining a meteorological simulation series under M groups of climate change scenarios and driving the basin hydrological model and the machine learning model to simulate a basin hydrological process under a future scenario; establishing a water and heat coupling balance equation of the basin to obtain annual average underlying surface feature parameters of the basin; extracting feature values of a flood duration and a flood volume and with the feature parameters as co-variates, establishing a joint probability distribution function; obtaining a joint return period of the flood duration and the flood volume; based on a dataset of the shared socioeconomic pathway, deriving a social economic exposure degree of future flood risk increase.

### CROSS-REFERENCE TO RELATED APPLICATIONS

Pursuant to 35 U.S.C. § 119 and the Paris Convention Treaty, this application claims foreign priority to Chinese Patent Application No. 202210650913.2 filed Jun. 9, 2022, the contents of which, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to the field of hydrological disaster evaluation, and more particularly to a flood risk prediction method under drive of hydrological cycle variation.

Global climatic change brings changes to the energy budget and water circulation process of the land-atmosphere system. Frequent occurrence of extreme climatic disasters such as rainstorms and floods poses a huge challenge to the sustained development of social economic system and ecological environment. China is one of regions most severely stricken by flood disasters and the climatic temperature rise rate is higher than a global average level. By the end of this century, the temperature will increase by 4° C., which severely threatens the flood prevention safety, water supply safety, grain safety, energy safety and ecological environmental safety of China. Deep understanding of the flood evolution under climatic change scenario and its social economic influence will be of great significance for predicting future extreme climatic disaster risk, preventing and reducing disasters and performing adaptive management.

In recent years, scholars at home and abroad researched on the evolution law of future floods in combination with global climate model ensemble and basin hydrological models and achieved a certain application effect. But, engineering measures such as dams, reservoirs, agricultural irrigation, water diversion and inter-basin water transfer etc. usually damage the consistency of the underlying surface, resulting in a large error of the hydrological models of basins. The existing literature does not consider an error caused by human activity interference to runoff simulation, and thus a large simulation error usually occurs. At the same time, in the engineering practices of the current stage in China, a single-variate same-frequency method is mainly used to measure a flood risk. This method assumes that a flood peak is completely correlated with flood volumes of different periods, which is not in compliance with the objective law of flood events.

Due to the influence of global climate change and human activity, the hydrological cycle process is significantly varied, the flood situation is aggravated, and the consistency hypothesis in the traditional frequency analysis is challenged. The global climate model is an effective tool to evaluate the influence of the future climate change on the hydrological cycle. Scholars propose to use the model to simulate the future meteorological hydrological situations and analyze the non-consistent evolutional features of the drought events and it is difficult to select an appropriate physical factor as an explanation variate in researches. The Budyko formula of water and heat balance equation considers regional water balance and energy budget balance and can well reflect the influence of the human activities on underlying surface conditions and runoff yield and concentration features. But, the existing literature does not use this method to consider bivariate flood features under the joint drive of future climate change and the underlying surface, which restricts scientific prediction for bivariate flood events under the drive of hydrological cycle variation.

### SUMMARY

To overcome the defects in the prior arts, the disclosure provides a flood risk prediction method under drive of hydrological cycle variation. The method fully considers non-consistency features of a hydrological series under the influence of climate change and underlying surface human activities and can effectively represent change features of a future flood under the drive of water cycle variation and can provide important and strongly-operable reference basis for basin flood risk evaluation and early warning under change environment.

In order to solve the above technical problems, the disclosure adopts the following technical solution.

Provided is a flood risk prediction method under drive of hydrological cycle variation, including the following steps:

at step 1, collecting basic meteorological hydrological data of a basin by using a data collection and storage box, wherein the basic meteorological hydrological data includes data of M global climate model (GCMs) and data of shared socioeconomic pathway;

at step 2, based on the data collected at step 1, deriving a relative humidity and a specific humidity, and based on the observed meteorological hydrological data, calibrating a basin hydrological model and a machine learning model;

at step 3, based on the data of the GCM ensemble collected at step 1 and a quantile deviation correction method, obtaining a meteorological simulation series under M groups of climate change scenarios and driving the basin hydrological model and the machine learning model calibrated at step 2 by using the meteorological simulation series to simulate a basin hydrological process under a future scenario;

at step 4, based on the meteorological hydrological series simulated in step 3, establishing a water and heat coupling balance equation of the basin to obtain annual average underlying surface feature parameters of the basin;

at step 5, based on the basin hydrological process simulated in step 3 and an annual maximum sampling method, extracting feature values of a flood duration and a flood volume and with the annual average underlying surface feature parameters of the basin obtained in step 4 as co-variates, establishing a joint probability distribution function of the flood duration and the flood volume under non-consistency conditions;

at step 6, based on the joint probability distribution function established in step 5 and a most possible combination scenario of the flood duration and the flood volume in a historical period, obtaining a joint return period of the flood duration and the flood volume of each year in the future under the non-consistency conditions and evaluating influence of the climate change and the underlying surface human activities on the future flood situation of the basin;

at step 7, based on the joint return period obtained in step 6 and the data set of the shared socioeconomic pathway collected in step 1, deriving a social economic exposure degree of future flood risk increase.

Furthermore, the meteorological hydrological data collected by using the data collection and storage box in step 1 further includes a daily flow series of a basin control hydrological station and meteorological data of an ERA5 reanalysis product.

Furthermore, the step 2 further specifically includes the following sub-steps:

at sub-step 2.1, deriving the relative humidity and the specific humidity based on the meteorological data of the ERAS reanalysis product;

at sub-step 2.2, based on daily runoff data observed by the hydrological station and a series of a daily precipitation, a daily maximum temperature and a daily minimum temperature of the ERAS reanalysis product, with a knowledge graph embedding (KGE) with a maximum efficiency coefficient as a target function, calibrating a GR4J hydrological model to obtain a preliminary simulation runoff;

at sub-step 2.3, performing statistical analysis for a daily runoff process preliminarily simulated in step 2.2 and a measured daily runoff process to determine a lag time affecting the measured daily runoff;

at sub-step 2.4, based on the relative humidity and the specific humidity derived in step 2.1 and the lag time determined in step 2.3, correcting the daily runoff process simulated in step 2.2 by using a long short term memory (LSTM) neural network model, thus reducing a hydrological model error caused by human activities.

Furthermore, in step 2.2, the KGE with the maximum efficiency coefficient is the target function as follows:

KGE=1−\sqrt{(r−1)²+(α−1)²+(β−1)²}

in the above formula, r represents a Pearson linear correlation coefficient of a simulated series and a measured series; α represents a ratio of variances of the simulated series and the measured series; β represents a ratio of means of the simulated series and the measured series; KGE efficiency coefficient is in a range of (−∞, 1), wherein when KGE=1, it indicates that the simulated series and the measured series are perfectly matched.

Furthermore, the scenarios selected in M GCMs include three scenarios of a historical period and a future period: SSP126, SSP245 and SSP585; the meteorological variates selected include daily precipitation, daily average temperature, daily maximum temperature, daily minimum temperature, specific humidity, relative humidity, wind velocity, and short wave radiation and long wave radiation data, and meanwhile, year-scale potential evapotranspiration data output by GCMs under three SSP scenarios is obtained.

Furthermore, obtaining a future meteorological series by correcting the output of the GCMs by the quantile deviation correction method in step 3 specifically includes: calculating a difference between a GCM output variate and an observed meteorological variate in terms of each quantile, and removing the difference from each quantile that the GCMs output future scenarios to obtain a future corrected GCM climate prediction.

Furthermore, the step 4 specifically includes:

at sub-step 4.1, based on the meteorological hydrological series simulated in step 3 and a water balance equation, calculating an actual year-scale evapotranspiration under the climate scenario in the following formula: ET=Py−Ry wherein ET is an actual evapotranspiration, Py is an annual precipitation, and Ry is an annual runoff volume;

at sub-step 4.2, selecting a time window, calibrating a feature parameter of the water and heat coupling balance equation as w by the least square method based on the actual evapotranspiration ET obtained in step 4.1, where the annual average water and heat coupling balance equation is:

$$\frac{E T}{P} = 1 + \frac{P E T}{P} - {[ 1 + {( \frac{P E T}{P} )}^{w} ]}^{1 / w}$$

in the above formula, P refers to precipitation data output by GCMs, and PET refers to potential evapotranspiration data output by GCMs.

Furthermore, step 5 specifically includes:

at sub-step 5.1, based on the basin hydrological process simulated in step 3, with a maximum daily flow as a determination rule, identifying an annual maximum flood process, and then calculating a duration D and a flood volume S of the flood process;

at sub-step 5.2, based on the duration D and the flood volume S calculated in step 5.1, with a gamma distribution function as a marginal distribution function of the flood duration and the flood volume, establishing the marginal distribution function of the gamma distribution function under the consistency conditions;

at sub-step 5.3, based on the marginal distribution function obtained in step 5.2, with the annual average underlying surface feature parameters of the basin obtained in step 4 as co-variates, constructing a Copula-based joint probability distribution function of the flood duration and the flood volume under the non-consistency conditions.

Furthermore, obtaining the joint return period of the flood duration and the flood volume of each year in the future in step 6 includes:

giving a joint return period Tₒᵣ, calculating a most possible combination of the flood duration and the flood volume of each year under the conditions of Tₒᵣ based on the joint probability distribution function of the flood duration and the flood volume established in step 5, wherein a most possible combination mode of the flood duration and the flood volume is a combination with a largest joint probability density function on an isoline of the joint return period Tₒᵣ, and then calculating an arithmetic mean of the flood durations and the flood volumes respectively to obtain the feature values of the flood duration and the flood volume of a historical period;

substituting the obtained feature values of the flood duration and the flood volume of the historical period into a most possible combination model of a future period to obtain a new joint return period of each year.

Furthermore, step 7 specifically includes:

based on the new joint return period T_{f}(k) of each year of the future period obtained in step 6, denoting the given return period of the historical period as Tₕ; wherein, if Tⱼ(k)<Tₕ, the flood risk of the k-th year is increased and otherwise decreased; a social economic exposure degree of the future period is measured as follows:

$${E}_{p o p} = \frac{I ( {T}_{h} - {T}_{f} ( k ) ) ▯ {POP}_{k}}{{{\sum }_{k = {N}_{1}}}^{k = {N}_{2}} PO {P}_{k}} \times 100 \% ;$$

$${E}_{G D P} = \frac{I ( {T}_{h} - {T}_{f} ( k ) ) ▯ {GDP}_{k}}{{{\sum }_{k = {N}_{1}}}^{k = {N}_{2}} {GDP}_{k}} \times 100 \% ;$$

in the above formula, Eₚₒₚ and E_{GDP} represent population and GDP exposure degrees affected by flood risk increase respectively; POPₖ and GDPₖ represent the population and the GDP of the k-th year respectively, which are obtained in step 1; I(·) is an indicator function, which is denoted as 1 when Tₕ−Tⱼ(k)>0, otherwise denoted as 0; N₁ and N₂ represent start and end years of a research period respectively.

Compared with the prior arts, the disclosure has the following beneficial effects.

1. Scientifically reasonable and close to actual engineering situations

The disclosure fully considers the non-consistency features of the hydrological series under the influence of climate change and underlying surface human activities. With the feature parameters of Fuh Baw-puh formula as covariates, a time varying Copula model is constructed based on the non-consistency of the hydrological series, having strong physic significance and statistics basis and effectively representing change features of the future floods under the drive of water cycle variation.

2. Capable of providing engineering reference value for coping with the future climate disasters and scientifically preparing emission reduction strategy.

The disclosure combines climate multi-model ensemble, the hydrological model, the water and heat balance equation, and the most possible combination scenario method with the basin drought situations to provide important and strongly-operable reference basis for basin flood risk evaluation and early warning under change environment as well as engineering reference value for coping with the future climate disasters and scientifically preparing emission reduction strategy.

### BRIEF DESCRIPTIONS OF THE DRAWINGS

FIG. 1 is a specific flowchart illustrating a flood risk prediction method according to an embodiment of the disclosure;

FIG. 2 is a schematic diagram illustrating change of a correlation coefficient of a daily measured runoff and a simulated runoff under different lag times according to an embodiment of the disclosure; and

FIG. 3 is a schematic diagram illustrating a Budyko water and heat balance equation according to an embodiment of the disclosure.

### DETAILED DESCRIPTIONS OF EMBODIMENTS

The technical solutions of the embodiments of the disclosure will be clearly and fully described below in combination with the embodiments of the disclosure. Apparently, the embodiments described herein are only some of the embodiments of the disclosure rather than all embodiments. All other embodiments obtained by those skilled in the art based on these embodiments of the disclosure without making creative work shall all fall within the scope of protection of the disclosure.

It should be noted that in a case of no conflict, the embodiments of the disclosure and the features of the embodiments can be mutually combined.

The disclosure will be further described in combination with the specific embodiments but will not be limited to these embodiments.

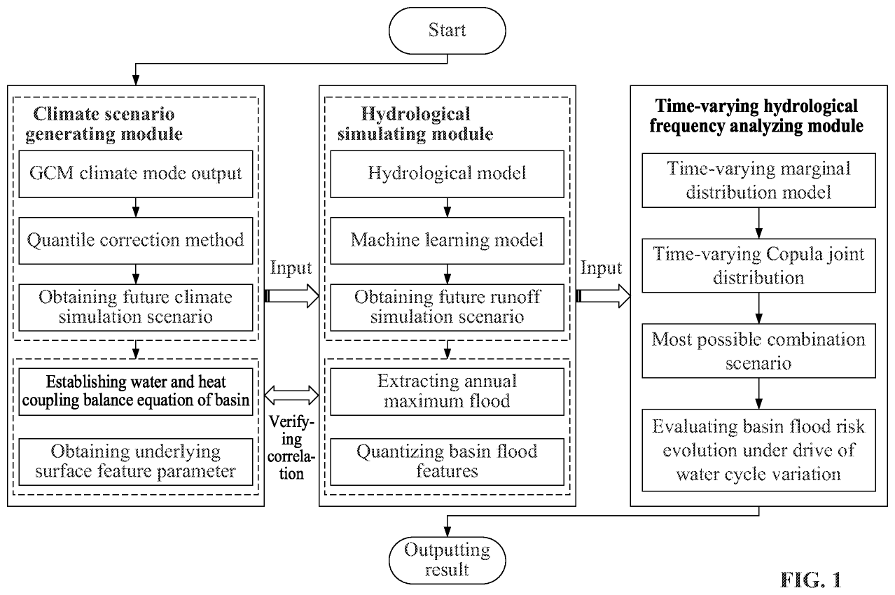

As shown in FIG. 1, an embodiment of the disclosure provides a flood risk prediction method under drive of hydrological cycle variation. The method includes the following steps.

At step 1, basic meteorological hydrological data of a basin is collected by using a data collection and storage box, where the basic meteorological hydrological data mainly includes a daily flow series of a basin control hydrological station, output data of M global climate model (GCMs), meteorological data of an ERAS reanalysis product, and shared socioeconomic pathway data. Specifically, the step includes the following sub-steps.

At sub-step 1.1, by using the data collection and storage box, the daily flow series of the basin control hydrological station is collected, and meteorological data such as precipitation, 2m temperature, 2m dew point temperature, wind velocity, atmospheric pressure, short wave radiation and long wave radiation are obtained from an ERAS reanalysis data set.

In the disclosure, with a basin as a research unit, the daily flow series of the basin control hydrological station is firstly collected and then hourly data of ERAS is collected. ERA5 is the fifth generation atmospheric reanalysis dataset of European Centre for Medium-range Weather Forecasts and has a spatial resolution of 0.25° and can provide hourly meteorological data covering the world since 1979. In this embodiment, the hourly precipitation, 2m temperature, 2m dew point temperature, wind velocity, atmospheric pressure, short wave radiation and long wave radiation data of the ERA5 dataset between 1985 and 2014 are obtained for the research region, and converted based on time scale to obtain a daily series and finally obtain an average day-scale meteorological series of the basin by Thiessen polygon method.

At sub-step 1.2, by using the data collection and storage box, daily meteorological data output by M global climate models (GCMs) is collected.

In order to estimate the future climate scenarios, M Global Climate Models (GCMs) published by Coupled Model Inter-comparison Project Phase6 (CMIP6) lately are used. CMIP6 uses a matrix framework of shared socioeconomic pathway (SSP) and Representative Concentration Pathway (RCP). The scenarios selected in the disclosure include three scenarios of a historical period and a future period (SSP126, SSP245 and SSP585), and meteorological variates selected are daily precipitation, daily average temperature, daily maximum temperature, daily minimum temperature, specific humidity, relative humidity, wind velocity, short wave radiation and long wave radiation data; year-scale potential evapotranspiration data output by the GCMs under three SSP scenarios is obtained at the same time; The historical period is set to be between 1985 and 2014 and the future period is set to be between 2015 and 2100.

At sub-step 1.3, population and GDP data provided by a dataset of the shared socioeconomic pathway of the research basin is collected using the data collection and storage box.

In order to evaluate a social economic risk possibly caused by a flood event, the population and GDP data of three shared socioeconomic pathways sustainable development (SSP1), medium development (SSP2) and normal development (SSP5) is considered, and in combination with corresponding greenhouse gas emission scenarios RCP, the output data of a total of three matrix frameworks SSP126, SSP245 and SSP585 is used. There are several international organizations providing the population and GDP simulation data of the shared socioeconomic pathway. The disclosure uses an estimated dataset under the universal two-child policy published by the open source of China Nanjing University of Information Science and Technology. This product considers each population and economic census result of China and yearly statistics yearbook and estimates the social economic indexes of 2010 to 2100 of China based on Cobb-Douglas model and population-development-environment analysis model. This dataset is one of current datasets closest to the situations of China, which is widely applied to the socioeconomic risk evaluation of extreme hydrological events.

After the grid-scale population and GDP data is obtained by this embodiment, the average population and GDP series of the basin under the future climate change scenario is derived by Thiessen polygon method.

At step 2, based on the meteorological data collected at step 1, a relative humidity and a specific humidity are derived, and based on the observed meteorological hydrological data, a basin hydrological model and a machine learning model are calibrated.

Step 2 includes the following sub-steps.

At sub-step 2.1, deriving the relative humidity and the specific humidity based on the meteorological data of the ERA5 dataset specifically includes the followings:

The Clausius-Clapeyron thermodynamic equation can quantitatively describe a nonlinear relationship between a saturated vapor pressure eₛₐₜ and a temperature T:

$${e}_{sat} ( T ) = {e}_{s 0} exp [ \frac{{L}_{v}}{{R}_{v}} ( \frac{1}{{T}_{0}} - \frac{1}{T} ) ] \qquad ( 1 )$$

in the above formula, T₀ and eₛ₀ are integral constant, which respectively correspond to 273.16 K and 611 Pa; Lᵥ is a vaporization latent heat, which is 2.5×10⁶ J kg⁻¹; Rᵥ is a vapor gas constant which is 461 J kg⁻¹ K⁻¹.

The dew point temperature refers to a temperature when the air is cooled to vapour saturation under invariable vapour content and atmospheric pressure, which can be substituted into the Clausius-Clapeyron equation to measure an actual vapor pressure. the 2m temperature (T₂ₘ) and the dew point temperature (T_{dew}) in the ERA5 are respectively substituted into the formula (1) to derive a near-ground relative humidity RH=eₛₐₜ(T_{dew})/eₛₐₜ(T₂ₘ), where eₛₐₜ represents a saturated vapour pressure.

The specific humidity q is a ratio of a vapour weight to a total weight of air mass, which can be derived using the ERA5 near-ground atmospheric pressure p and the dew point temperature (T_{dew}) in the following formula:

$$q = 0.622 \frac{{e}_{sat} ( {T}_{d e w} )}{p - 0.378 {e}_{sat} ( {T}_{d e w} )} \qquad ( 2 )$$

At sub-step 2.2, based on daily runoff data observed by the hydrological station and a series of a daily precipitation, a daily maximum temperature and a daily minimum temperature of the ERA5 dataset, with a knowledge graph embedding (KGE) with a maximum efficiency coefficient as a target function, a GR4J hydrological model is calibrated to obtain a preliminary simulation runoff.

GR4J hydrological model is a lumped conceptual hydrological model having only four parameters. This model has the advantages of simple structure, less parameters and high accuracy and the like and is widely applied. This model mainly consists of two nonlinear reservoirs, which are a runoff yield reservoir and a runoff concentration reservoir. It belongs to the conventional technology of the prior art.

The KGE with the maximum efficiency coefficient is the target function as follows:

KGE=1−\sqrt{(r−1)²+(α−1)²+(β−1)²} (3)

in the above formula, r represents a Pearson linear correlation coefficient of a simulated series and a measured series; a represents a ratio of variances of the simulated series and the measured series; β represents a ratio of means of the simulated series and the measured series; KGE efficiency coefficient is in a range of (−∞, 1), wherein when KGE=1, it indicates that the simulated series and the measured series are perfectly matched. Calibrating the GR4J hydrological model is the conventional technology of the prior art and will not be redundantly described herein.

At sub-step 2.3, statistical analysis is performed for a daily runoff process preliminarily simulated in step 2.2 and a measured daily runoff process to determine a lag time affecting the measured daily runoff.

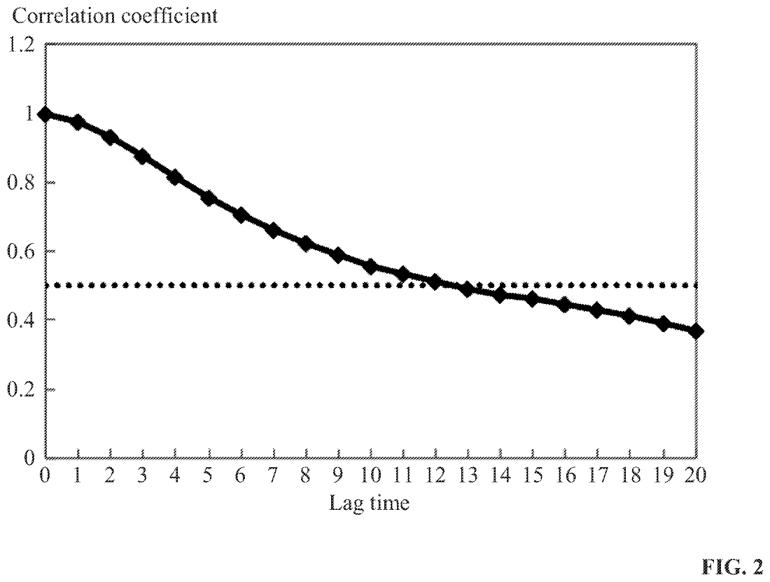

As shown in FIG. 2, it shows a schematic diagram illustrating change of a correlation coefficient of a daily measured runoff and a simulated runoff under different lag times. The correlation coefficient of the simulated runoff and the measured runoff usually gradually decreases along with extension of the lag time. Further, an appropriate correlation threshold may be selected to determine a time length of the simulated runoff joining the measured runoff to establish a machine learning model. For example, the lag time may be 0.5.

At sub-step 2.4, based on the relative humidity and the specific humidity derived in step 2.1 and the lag time determined in step 2.3, the daily runoff process simulated in step 2.2 is corrected by using a long short term memory (LSTM) neural network model, thus reducing a hydrological model error caused by human activities.

This embodiment constructs a long short-term memory (LSTM) neural network model having three layers of neural network architecture to generalize the storage function of the dams, reservoirs and water transfer projects for the basin and improve the hydrological simulation accuracy. This embodiment uses a neural network interval simulation mean value method to independently run the neural network model several times and takes a mean value as a final simulation result, so as to reduce uncertainty.

In order to solve gradient explosion and gradient disappearance caused by a dynamic neural network of Nonlinear Auto Regressive with eXogenous inputs (NARX) during deep learning process (hidden layer number ≥2 layers), the LSTM neural network introduces to the hidden layer of the NARX neural network a storage unit, i.e. input gate, forget gate, self-recurrent connection and output gate, to select to memorize current information or forget past memorized information (e.g. precipitation—runoff mapping relationship) so as to enhance the long term memory capability of the NARX neural network. To sum up, the LSTM neural network changes each hidden layer of the NARX dynamic neural network into a storage unit having memory function, which is simply called LSTM unit, whereas its input layer and output layer are same as the NARX dynamic neural network.

With the meteorological data such as daily precipitation, daily average temperature, daily maximum temperature, daily minimum temperature, specific humidity, relative humidity, wind velocity, short wave radiation and long wave radiation data and the like obtained by ERA5 product, and the simulated runoff series and the measured runoff series as inputs, after the LSTM model is calibrated, the simulated runoff series can be corrected using the model in the following equation expressed as:

R_{cor}(t)=F_{LSTM}[QM(t−1), QM(t−1), QM(t−2), . . . , QM(t−N)] (4)

in the above formula, R_{cor}(t) represents a corrected runoff at the moment of t, QM(t) represents input variates for calibrating the LSTM model, including the daily runoff series simulated by the GR4J model, and average meteorological data of a basin area derived by ERA5; QM(t−1) represents a simulated runoff and meteorology series at the moment of t−1, QM(t−N) represents a simulated runoff and meteorology series at the moment of t−N, N represents a lag time determined by the LSTM model; F_{LSTM} represents an LSTM model.

Furthermore, by using the conventional technology of the prior art, mini-batch gradient descent, the LSTM model is trained to optimize the parameters of the model.

At step 3, based on the data of the GCM ensemble collected at step 1 and a quantile deviation correction method, a meteorological simulation series under M groups of climate change scenarios is obtained and the basin hydrological model and the machine learning model calibrated at step 2 are driven by using the meteorological simulation series to simulate a basin hydrological process under a future scenario. Specifically, the step includes the following sub-steps.

At sub-step 3.1, based on the GCM ensemble and the quantile deviation correction method, a meteorological simulation series under M groups of climate change scenarios is obtained.

The GCM outputs are corrected using the quantile deviation correction method to obtain a future meteorological series, which specifically includes: calculating a difference between a GCM output variate and an observed meteorological variate in terms of each quantile (0.01 to 0.99), and removing the difference from each quantile that the GCMs output future scenarios to obtain a future corrected GCM climate prediction. The temperature (and the specific humidity, relative humidity, wind velocity, short wave radiation and long wave radiation) is corrected as follows:

T_{adj,d}=T_{GCM,d}+(T_{obs,Q}−T_{GCM,ref,Q}) (5)

The precipitation is corrected as follows:

P_{adj,d}=P_{GCM,d}×(P_{obs,Q}/P_{GCM,ref,Q}) (6)

in the above formula, T and P respectively correspond to a temperature (specific humidity, relative humidity, wind velocity, short wave radiation and long wave radiation) and a precipitation, adj represents a corrected series, obs represents observed data, ref and fut respectively represent a historical reference period and a future prediction period, d represents daily data and Q represents each quantile.

At sub-step 3.2, the basin hydrological model and the machine learning model are driven using the corrected meteorological simulation series to simulate a basin hydrological process under a future scenario. The step specifically includes the followings:

The meteorological data under the climate change scenario corrected at sub-step 3.1 is input to the GR4J model and the machine learning model calibrated at step 2 to simulate a daily runoff series under the future climate change scenario.

At step 4, based on the meteorological hydrological series simulated in step 3, a water and heat coupling balance equation of the basin is established to obtain annual average underlying surface feature parameters of the basin.

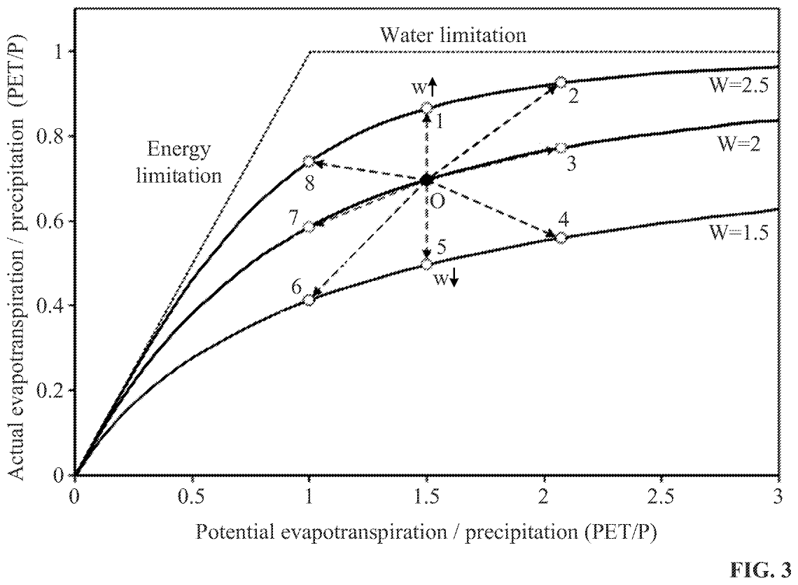

In this embodiment, as shown in FIG. 3, it gives a schematic diagram of a Budyko water and heat balance equation. This step includes the following sub-steps.

at sub-step 4.1, based on the data in the meteorological hydrological series simulated in step 3 and a water balance equation, an actual year-scale evapotranspiration under the climate change scenario is calculated in the following formula: ET=Py−Ry wherein ET is an actual evapotranspiration, Py is an annual precipitation, and Ry is an annual runoff volume;

at sub-step 4.2, a time window is selected (based on actual requirements), and feature parameters of the water and heat coupling balance equation are calibrated as w by the least square method based on the actual evapotranspiration ET obtained in sub-step 4.1, where the annual average water and heat coupling balance equation is:

$$\frac{E T}{P} = 1 + \frac{P E T}{P} - {[ 1 + {( \frac{P E T}{P} )}^{w} ]}^{1 / w} \qquad ( 7 )$$

in the above formula, P refers to precipitation data output by GCMs, and PET refers to potential evapotranspiration data output by GCMs.

Particularly, in this embodiment, the time window is selected as 11 years.

At step 5, based on the basin hydrological process simulated in step 3 and an annual maximum sampling method, feature values of a flood duration and a flood volume are extracted and with the feature parameters w of the water and heat coupling balance equation in step 4 as co-variates, a Copula-based joint probability distribution function under non-consistency conditions is established.

At sub-step 5.1, based on the hydrological process simulated in step 3 and the annual maximum sampling method, the feature values of the flood duration and the flood volume are extracted.

Based on the daily runoff series under the climate change scenario obtained in sub-step 3.2, with a maximum daily flow as a determination rule, an annual maximum flood process is identified, and then a duration D and a flood volume S of the flood process are calculated.

At sub-step 5.2, based on the duration D and the flood volume S calculated in sub-step 5.1, with a gamma distribution function as a marginal distribution function of the flood duration and the flood volume, the marginal distribution function of the gamma distribution function under the consistency conditions is established.

Let X represent a flood feature quantity (flood duration D and flood volume S), with the gamma distribution function as the marginal distribution function of the flood duration and the flood volume, a probability density function of the gamma distribution function under the consistency conditions is expressed as:

$$f ( x ) = \frac{1}{{β}^{α} Γ ( α )} {x}^{α - 1} {e}^{- x / β} x > 0 \qquad ( 8 )$$

where α and β represent shape and scale parameters; Γ(α) represents a gamma function of α. In a time varying parameter model, α and β are no longer fixed values, and can change along with the co-variates period by period. For a time varying moment corresponding to the marginal distribution function at the moment of t, if the scale parameter αₜ and the shape parameter βₜ both are represented by a monotonic function of the explanation variate w^{t}, which is as follows:

g(αₜ)=α₁₀α₁w^{t} g(βₜ)=α₂₀+α₂w^{t} (9)

in the above formula, g(19 ) represents a monotonic connection function, the specific form of which is determined by a definition domain of a statistic parameter θₓ; when θₓ ∈ R, g(θₓ)=θₓ (R represents a real number set); when θₓ>0, g(θₓ)=ln(θₓ); w^{t} represents a value of the co-variate at the moment of t, αᵢ(i=1, 2;10, 20) represents a parameter of the model. Thus, under the non-consistency conditions, the probability density function of the gamma distribution function is expressed as:

$$f ( x \vert g ( {α}_{t} ) , g ( {β}_{t} ) ) = \frac{1}{{( g ( {β}_{t} ) )}^{g ( {α}_{t} )} Γ ( g ( {α}_{t} ) )} {x}^{g ( {α}_{t} ) - 1} {e}^{- x / g ( {β}_{t} )} x > 0 \qquad ( 10 )$$

At sub-step 5.3, based on the marginal distribution function obtained in step 5.2, with the annual average underlying surface feature parameters of the basin obtained in step 4 as co-variates, a Copula-based joint probability distribution function of the flood duration and the flood volume under the non-consistency conditions is constructed.

In any one of M groups of climate scenarios of the basin, a joint probability distribution function with G-H Copula function being a drought duration and a drought flood volume is selected, and the parameter θ of the Copula function is replaced with the time varying parameter θ^{t}_{c}:

$${C}_{{θ}_{c}^{t}} = exp \{ - {[ {( - {lnu}^{t} )}^{{θ}_{c}^{t}} + {( - {lnv}^{t} )}^{{θ}_{c}^{t}} ]}^{1 / {θ}_{c}^{t}} \} \qquad ( 11 )$$

where C_{θ}_{_{c}}_{^{t}} is a Copula joint distribution function, C_{θ}_{_{c}}_{^{t}} is in the range of (1,∞); u^{t} and v^{t} re the marginal distribution functions of the duration D and the flood volume S respectively, u^{t}=F_{D}^{t}(d) and v^{t}=F_{S}^{t}(S). Based on the definition of the Copula function, the non-consistency bivariate Copula function can be expressed as:

F^{t}(d^{t},s^{t})=C[F_{D}^{t}(s|θ_{D}^{t}), F_{S}^{t}(s|θ_{S}^{t})|θ_{c}^{t}] (12)

in the above formula, F^{t}(d^{t}, s^{t}) represents a time varying joint distribution function of D and S; F_{D}^{t}(·) and F_{S}^{t}(·)θ_{S}^{t} correspond to the time varying marginal distribution functions of the variates D and S respectively; θ_{D}^{t} and θ_{S}^{t} represent time varying parameters of the variates D and S. Further, the parameter of the time varying Copula function is expressed with a covariate w:

g_{c}(θ_{c}^{t})=b₀+b₁w^{t} (13)

in the above formula, g_{c})·) represents a link function of the Copula function; when θ_{c}^{t}>0 (for G-H Copula), g_{c}(θ_{c}^{t})=ln (θ_{c}^{t}); b₀, b₁ represent the parameters of the model respectively.

At step 6, based on a most possible combination scenario of the flood duration and the flood volume in a historical period, a joint return period of the flood duration and the flood volume of each year in the future under the non-consistency conditions is obtained and the influence of the climate change and the underlying surface human activities on the future flood situation of the basin is evaluated.

In this embodiment, the step includes the following sub-steps.

At sub-step 6.1, the most possible combination scenario of the flood duration and the flood volume of the historical period is obtained.

OR return period is used as a measure index of the flood and is defined as follows:

Tₒᵣ^{t}(d^{t}, s^{t})=1/[1−F^{t}(d^{t}, s^{t})] (14)

in the above formula, Tₒᵣ^{t}(d^{t}, s^{t}) is a time varying OR joint return period

which is denoted in the unit of year and other symbols are the same as above.

The most possible combination mode of the flood duration and the flood volume is a combination (d*(t), s*(t)) with a largest joint probability density function on an isoline of the return period, which is solved in the following equation:

$$\{ \begin{matrix}max : {f}^{t} ( {d}^{t} , {s}^{t} ) = {c}_{{θ}^{t}} ( {F}_{D}^{t} ( d ) , {F}_{S}^{t} ( s ) ) {f}_{{D}_{t}} ( d ) {f}_{{S}_{t}} ( s ) \\ {C}_{{θ}^{t}} ( {F}_{D}^{t} ( d ) , {F}_{S}^{t} ( s ) ) = 1 - 1 / {T}^{o r} , t = 1 , 2 , … , n\end{matrix} \qquad ( 15 )$$

in the above formula, f^{t}(d^{t},s^{t}) represents a density function of the time varying joint distribution function of the duration D and the flood volume S; c_{θ}_{^{t}}=dC_{θ}_{^{t}}(u, v)/dudv represents a density function of the time varying

Copula joint distribution function; u and v correspond to the cumulative probability densities of the duration D and the flood volume S respectively; f_{D}_{ₜ}(d) and f_{S}_{ₜ}(S) represent the density functions of the marginal distribution functions of F_{D}^{t}(d) and F_{S}^{t}(S) respectively; T^{or} is a return period of the duration D and the flood volume S, which is one form of the joint return period.

Furthermore, based on Lagrange Multiplier Method, the most possible combination can be solved in the following solving equation:

φₜ(d, s)=c_{θ}_{^{t}}(F_{D}^{t}(d), F_{S}^{t}(S))f_{D}_{ₜ}(d)f_{S}_{ₜ}(S)+λₜ[C_{θ}_{^{t}}(F_{D}^{t}(d), F_{S}^{t}(S))−1+1/T^{or}] (16)

in the above formula, λₜ represents a Lagrange multiplier corresponding to a time t; to maximize the value of the probability density function f^{t}(d^{t},s^{t}), let the derivative be 0 to obtain a nonlinear equation of the most possible combination:

$${φ}_{d t} = {f}_{{S}_{t}} ( s ) [ {c}_{u}^{t} {f}_{{D}_{t}}^{2} ( d ) + {c}_{{θ}^{t}} ( u , v ) {f}_{{D}_{t}}^{′} ( d ) ] + {λ}_{t} \frac{\partial {c}_{{θ}^{t}} ( {F}_{D}^{t} ( d ) , {F}_{S}^{t} ( s ) )}{\partial u} {f}_{{D}_{t}} ( d ) = 0 \qquad ( 17 )$$

$${φ}_{s t} = {f}_{{D}_{t}} ( d ) [ {c}_{v}^{t} {f}_{{S}_{t}}^{2} ( s ) + {c}_{{θ}^{t}} ( u , v ) {f}_{{S}_{t}}^{′} ( s ) ] + {λ}_{t} \frac{\partial {c}_{{θ}^{t}} ( {F}_{D}^{t} ( d ) , {F}_{S}^{t} ( s ) )}{\partial v} {f}_{{S}_{t}} ( s ) = 0$$

$${φ}_{λ t} = {c}_{{θ}^{t}} [ {F}_{D}^{t} ( d ) , {F}_{S}^{t} ( s ) ] - ( 1 - 1 / {T}_{o r} ) = 0$$

in the above formula,

$${c}_{u}^{t} = \frac{\partial {c}_{{θ}^{t}} ( u , v )}{\partial u} , {c}_{v}^{t} = \frac{\partial {c}_{{θ}^{t}} ( u , v )}{\partial v} ;$$

f_{Dt}^{t}(d) and f_{St}^{t}(S) are the derivatives of f_{D}_{ₜ}(d) and f_{S}_{ₜ}(S) respectively; the formula (17) can be solved by a numerical method (e.g. Newton method).

A joint return period Tₒᵣ is given. After the most possible combination of the flood duration and the flood volume of each year under the Tₒᵣ conditions in the historical period (1985 to 2014) is obtained by the above method, an arithmetic mean of the flood durations and the flood volumes is calculated respectively to obtain the feature values of the flood duration and the flood volume of the historical period.

At sub-step 6.2, a flood risk change under the drive of hydrological cycle variation is evaluated.

The feature values of the flood duration and the flood volume of the historical period obtained in sub-step 6.1 are substituted into a most possible combination model of a future period to obtain a new joint return period of each year. When the new joint return period of a year is greater than the given return period of the historical period, the flood risk is decreased, and otherwise increased. Finally, a mean value of joint return periods of the future period is calculated to evaluate the flood risk change of the future long series.

At step 7, based on the dataset of the shared socioeconomic pathway, a social economic exposure degree of the future flood risk increase is derived.

Based on the new return period T_{f}(k) of each year of the future period obtained in step 6, denoting the given return period of the historical period as Tₕ; wherein, if T_{f}(k)<Tₕ, the flood risk of the k-th year is increased and otherwise decreased; the social economic exposure degree of the future period is measured as follows:

$${E}_{p o p} = \frac{I ( {T}_{h} - {T}_{f} ( k ) ) ▯ {POP}_{k}}{{{\sum }_{k = {N}_{1}}}^{k = {N}_{2}} PO {P}_{k}} \times 100 \% \qquad ( 18 )$$

$${E}_{G D P} = \frac{I ( {T}_{h} - {T}_{f} ( k ) ) ▯ {GDP}_{k}}{{{\sum }_{k = {N}_{1}}}^{k = {N}_{2}} {GDP}_{k}} \times 100 \% \qquad ( 19 )$$

in the above formula, Eₚₒₚ and E_{GDP} represent population and GDP exposure degrees affected by flood risk increase respectively; POPₖ and GDPₖ represent the population and the GDP of the k-th year respectively, which are obtained in step 1; I(·) is an indicator function, which is denoted as 1 when Tₕ−Tⱼ(k)>0, otherwise denoted as 0; N₁ and N₂ represent start and end years of a research period respectively.

In the past researches, joint distributions of the historical period and the future period are usually directly constructed and the changes of the joint return periods of the two periods are compared to define the social economic exposure degree of the future period as 0 or 100%. This method cannot capture the inter-year change features of the flood risk and the dynamic attribute of the social economic index and there is a degree of unreasonableness. The disclosure may not only consider the non-consistency possibly caused by the future climate change but also dig out the inter-year features of the risk change and fully use the dynamic data of the shared socioeconomic pathway.

The above are only the preferred embodiments of the disclosure and do not limit the embodiments and the scope of protection of the disclosure. Those skilled in the art should realize that the solutions obtained by making equivalent substitutions or obvious changes based on the contents of the specification of the disclosure shall all fall within the scope of protection of the disclosure.

What is claimed is:

1. A flood risk prediction method under drive of hydrological cycle variation, the method comprising:
step 1. collecting basic observed meteorological hydrological data of a basin by using a data collection and storage box, wherein the basic meteorological hydrological data comprises data of M global climate models (GCMs) and data of a shared socioeconomic pathway;
step 2. according to the collected observed data in step 1, deriving a relative humidity and a specific humidity, and according to observed meteorological hydrological data, calibrating a basin hydrological model and a machine learning model;
step 3. according to the data of the GCM ensemble collected in step 1 and a quantile deviation correction method, obtaining a meteorological simulation series under M groups of climate change scenarios and driving the basin hydrological model and the machine learning model calibrated in step 2 by using the meteorological simulation series to simulate a basin hydrological process under a future scenario;
step 4. according to the meteorological hydrological series simulated in step 3, establishing a water and heat coupling balance equation of the basin to obtain annual average underlying surface feature parameters of the basin;
step 5. according to the basin hydrological process simulated in step 3 and an annual maximum sampling method, extracting feature values of a flood duration and a flood volume and with the annual average underlying surface feature parameters of the basin obtained in step 4 as co-variates, establishing a joint probability distribution function of the flood duration and the flood volume under non-consistency conditions;
step 6. according to the joint probability distribution function established in step 5 and a most possible combination scenario of the flood duration and the flood volume in a historical period, obtaining a joint return period of the flood duration and the flood volume of each year in the future under the non-consistency conditions and evaluating influence of the climate change and the underlying surface human activities on a future flood situation of the basin; and
step 7. according to the joint return period obtained in step 6 and a data set of the shared socioeconomic pathway collected in step 1, deriving a social economic exposure degree of future flood risk increase.

2. The method of claim 1, wherein the meteorological hydrological data further comprises a daily flow series of a basin control hydrological station and meteorological data of an ERA5 (the fifth-generation atmospheric reanalysis of the European Centre for Medium-Range Weather Forecasts) product.

3. The method of claim 2, wherein the step 2 comprises the following sub-steps:
sub-step 2.1, deriving the relative humidity and the specific humidity according to the meteorological data of the ERA5 reanalysis product;
sub-step 2.2, according to daily runoff data observed by the hydrological station and a series of daily precipitation, daily maximum temperature and daily minimum temperature of the ERA5 reanalysis product, with a knowledge graph embedding (KGE) with a maximum efficiency coefficient as a target function, calibrating a GR4J hydrological model to obtain a preliminary simulation runoff;
sub-step 2.3, performing statistical analysis for a daily runoff process preliminarily simulated in sub-step2.2 and a measured daily runoff process to determine a lag time affecting the measured daily runoff; and
sub-step 2.4, according to the relative humidity and the specific humidity derived in sub-step 2.1 and the lag time determined in sub-step 2.3, correcting the daily runoff process simulated in sub-step 2.2 by using a long short term memory (LSTM) model, thus reducing a hydrological model error caused by human activities.

4. The method of claim 3, wherein in sub-step 2.2, the KGE with the maximum efficiency coefficient is the target function as follows:
KGE=1−\sqrt{(r−1)²+(α−1)²+(β−1)²};
where, r represents a Pearson linear correlation coefficient of a simulated series and a measured series; a represents a ratio of variances of the simulated series and the measured series; β represents a ratio of means of the simulated series and the measured series; KGE efficiency coefficient is in a range of (−∞, 1); when KGE=1, it indicates that the simulated series and the measured series are well matched, and a higher KGE implies better performance.

5. The method of claim 1, wherein the scenarios selected in M GCMs comprise three shared socioeconomic pathways (SSP) of a historical period and a future period: SSP126, SSP245 and SSP585; meteorological variates selected comprise daily precipitation, daily average temperature, daily maximum temperature, daily minimum temperature, specific humidity, relative humidity, wind velocity, and short wave radiation and long wave radiation data, and meanwhile, year-scale potential evapotranspiration data output by GCMs under three SSP scenarios is obtained.

6. The method of claim 1, wherein obtaining a future meteorological series by correcting the output of the GCMs by the quantile deviation correction method in step 3 comprises: calculating a difference between GCM outputs and observed meteorological values for each quantile, and then removing the difference from the GCMs output to obtain a future corrected GCM climate prediction.

7. The method of claim 1, wherein the step 4 comprises:
sub-step 4.1: according to the meteorological hydrological series simulated in step 3 and a water balance equation, calculating an actual year-scale evapotranspiration under climate scenario according to the formula as follows: ET=Py−Ry, where ET is an actual evapotranspiration, Py is an annual precipitation, and Ry is an annual runoff volume; and
sub-step 4.2: selecting a time window, calibrating a parameter (w) of the water and heat coupling balance equation by the least square method according to the actual evapotranspiration ET obtained in sub-step 4.1, where an annual average water and heat coupling balance equation is:
$$\frac{E T}{P} = 1 + \frac{P E T}{P} - {[ 1 + {( \frac{P E T}{P} )}^{w} ]}^{1 / w} ;$$
where P refers to precipitation data output by GCMs, and PET refers to potential evapotranspiration data output by GCMs.

8. The method of claim 1, wherein step 5 comprises:
sub-step 5.1: according to the basin hydrological process simulated in step 3, with a maximum daily flow as a determination rule, identifying an annual maximum flood process, and calculating a duration D and a flood volume S of the annual maximum flood process;
sub-step 5.2: according to the duration D and the flood volume S calculated in sub-step 5.1, with a gamma distribution function as a marginal distribution function of the flood duration and the flood volume, establishing the marginal distribution function of the gamma distribution function under consistency conditions; and
sub-step 5.3: according to the marginal distribution function obtained in sub-step 5.2, with the annual average underlying surface feature parameters of the basin obtained in step 4 as co-variates, constructing a Copula-based joint probability distribution function of the flood duration and the flood volume under the non-consistency conditions.

9. The method of claim 1, wherein obtaining the joint return period of the flood duration and the flood volume of each year in the future in step 6 comprises:
giving a joint return period Tₒᵣ, and calculating a most possible combination of the flood duration and the flood volume of each year under the conditions of the joint return period Tₒᵣ according to the joint probability distribution function of the flood duration and the flood volume established in step 5; a most possible combination mode of the flood duration and the flood volume is a combination with a largest joint probability density function on an isoline of the joint return period Tₒᵣ, and then calculating an arithmetic mean of the flood durations and the flood volumes respectively to obtain the feature values of the flood duration and the flood volume of a historical period; substituting the obtained feature values of the flood duration and the flood volume of the historical period into a most possible combination model of a future period to obtain a new joint return period of each year.

10. The method of claim 1, wherein step 7 comprises:
according to the new joint return period T_{f}(k) of each year of the future period obtained in step 6, denoting the given return period of the historical period as Tₕ; if T_{f}(k)<Tₕ, the flood risk of the k-th year is increased and otherwise decreased; a social economic exposure degree of the future period is measured as follows:
$${E}_{p o p} = \frac{I ( {T}_{h} - {T}_{f} ( k ) ) ▯ {POP}_{k}}{{{\sum }_{k = {N}_{1}}}^{k = {N}_{2}} PO {P}_{k}} \times 100 \% ;$$
$${E}_{G D P} = \frac{I ( {T}_{h} - {T}_{f} ( k ) ) ▯ {GDP}_{k}}{{{\sum }_{k = {N}_{1}}}^{k = {N}_{2}} {GDP}_{k}} \times 100 \% ;$$
where, Eₚₒₚ and E_{GDP} represent population and GDP exposure degrees affected by flood risk increase respectively; POPₖ and GDPₖ represent the population and the GDP of the k-th year respectively, which are obtained in step 1; I(·) is an indicator function, which is denoted as 1 when Tₕ−T_{f}(k)>0, otherwise denoted as 0; N₁and N₂ represent start and end years of a research period respectively.
